(19) United States
(12) Patent Application Publication
(10) Pub. No.: US 2026/0010756 A1
(43) Pub. Date: Jan. 8, 2026

(54) SYSTEM AND METHOD FOR PERFORMING RECOVERY OF MISAPPROPRIATED INTERACTIONS VIA NEUROMORPHIC COMPUTING

(71) Applicant: BANK OF AMERICA CORPORATION, Charlotte, NC (US)

(72) Inventors: Nimish Ravindra Deshpande, Mumbai (IN); Amit Chauhan, Gurugram (IN); Jai Issrani, Delhi (IN); Ashwrish Mehra, Gurugram (IN); Yash Misra, Lucknow (IN); Gaurav Sachdeva, New Delhi (IN); Sumit Sethi, New Delhi (IN); Shikha Verma, Gurugram (IN)

(73) Assignee: BANK OF AMERICA CORPORATION, Charlotte, NC (US)

(21) Appl. No.: 18/762,382

(22) Filed: Jul. 2, 2024

(51) Int. Cl. G06N 3/042

(52) U.S. Cl. CPC G06N 3/042

(57) ABSTRACT

Embodiments of the present invention provide a system for performing recovery of misappropriated interactions via neuromorphic computing. The system is configured for receiving a recovery request associated with an unauthorized resource interaction from a user, extracting interaction data associated with the unauthorized resource interaction from a data repository, communicating with one or more external systems to gather third party information associated with third party entity linked with the unauthorized resource interaction, communicating with one or more internal systems to gather user recovery information associated with the user, passing the interaction data, the third party information, and the user recovery information to a Spiking Neural Network to determine if the recovery request is accurate, and processing or denying the recovery request based on determining if the recovery request is accurate.

### BACKGROUND

There exists a need for a system for performing recovery of misappropriated interactions via neuromorphic computing.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for performing recovery of misappropriated interactions via neuromorphic computing. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives a recovery request associated with an unauthorized resource interaction from a user, extracts interaction data associated with the unauthorized resource interaction from a data repository, communicates with one or more external systems to gather third party information associated with third party entity linked with the unauthorized resource interaction, communicates with one or more internal systems to gather user recovery information associated with the user, passes the interaction data, the third party information, and the user recovery information to a Spiking Neural Network to determine if the recovery request is accurate, and processes or denies the recovery request based on determining if the recovery request is accurate.

In some embodiments, the Spiking Neural Network is part of a neuromorphic computing device.

In some embodiments, the system comprises the neuromorphic computing device.

In some embodiments, the system is linked with the neuromorphic computing device.

In some embodiments, the present invention captures the interaction data during execution of the unauthorized resource interaction.

In some embodiments, the resource interaction is an online interaction.

In some embodiments, the resource interaction is an in-store interaction.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for performing recovery of misappropriated interactions via neuromorphic computing, in accordance with an embodiment of the invention;

FIG. 2 provides a block diagram illustrating the entity system 200 of FIG. 1, in accordance with an embodiment of the invention;

FIG. 3 provides a block diagram illustrating a misappropriated interaction recovery system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for performing recovery of misappropriated interactions via neuromorphic computing, in accordance with an embodiment of the invention; and

FIG. 6 provides a block diagram illustrating the process of performing recovery of misappropriated interactions via neuromorphic computing, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be a financial institution which may include herein may include any financial institutions such as commercial banks, thrifts, federal and state savings banks, savings and loan associations, credit unions, investment companies, insurance companies and the like. As described herein, a “user” may be a customer or a potential customer of the entity.

A “resource interaction” or “resource distribution” or “transaction” or “interaction” refers to any communication between a user and third party entity (e.g., merchant) and/or a financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the “point-of-transaction device” (POT) or “point of interaction device” or “interaction device” may be or include a merchant machine and/or server and/or may be or include the mobile device of the user may function as a point of transaction device. The embodiments described herein may refer to the use of a transaction, transaction event or point of transaction event to trigger the steps, functions, routines or the like described herein. In various embodiments, occurrence of a transaction triggers the sending of information such as alerts and the like. As used herein, a “bank account,” a “resource pool,” or a “resource account” refers to a checking account, savings account, money market account, business account, foreign currency account, brokerage accounts, retirement accounts, health savings account, cash management accounts, custodial accounts, and/or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), entertainment device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Further, the term “payment credential,” or “payment vehicle,” or “resource credentials,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As described herein, a Spiking Neural Network may be employed by the system of the invention employed for performing one or more operations. Spiking Neural Network is an artificial neural network that closely mimic natural neural networks. In addition to natural neuronal and synaptic states, the Spiking Neural Networks incorporate the concept of time into their propagating model. The neurons in the Spiking Neural Networks do not transmit information at each propagation cycle, but rather transmit information only when a membrane potential reaches a specific value, called the threshold. Membrane potential is an intrinsic quality of the neuron related to its membrane electrical charge. When the membrane potential reaches the threshold, the neuron fires, and generates a signal that travels to other neurons which, in turn, increase or decrease their potentials in response to this signal. A neuron model that fires at the moment of threshold crossing is also called a spiking neuron model.

With increase in technology, bad actors are finding new approaches to acquire resource credentials of users (e.g., credit card information) and perform unauthorized resource interactions using the misappropriated resource credentials. Once the authorized user identifies such unauthorized resource interactions, the authorized user may initiate a recovery process to recover the resources misappropriated in the authorized resource interaction. Upon receiving the recovery request from the authorized user, the recovery process may be initiated by an entity maintaining and/or managing resource pools of the user that is linked with the unauthorized resource interaction without any initial processing of whether recovery of resources will be successful or not. In the case where the recovery of resources is not successful, unnecessary utilization of processing power of various systems involved on both sides of the recovery claim takes place, thereby decreasing the efficiency of systems to perform the recovery of resources associated with other unauthorized resource interactions. As such, these exists a need for a system that can perform recovery of misappropriated interactions. The system of the invention solves this problem as discussed in detail below.

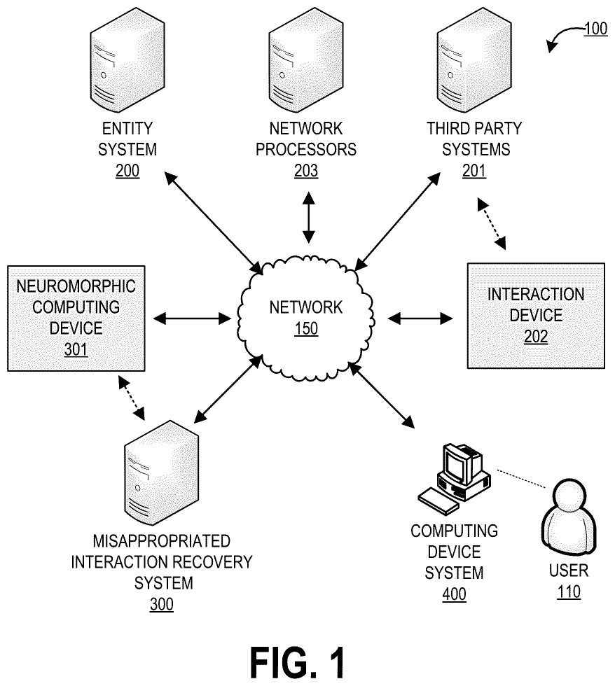

FIG. 1 provides a block diagram illustrating a system environment 100 for performing recovery of misappropriated interactions via neuromorphic computing, in accordance with an embodiment of the invention. As illustrated in FIG. 1, the environment 100 includes a misappropriated interaction recovery system 300, a neuromorphic computing device 301, an entity system 200, a computing device system 400, one or more third party systems 201, one or more interaction devices 202, and network processors 203. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200.

The entity system(s) 200 may be any system owned or otherwise controlled by an entity to support or perform one or more process steps described herein. In some embodiments, the entity is a financial institution. In some embodiments, the entity may be any organization that maintains one or more resource pools associated with the one or more users, where resources (e.g., funds) in the one or more resource pools may be used by the one or more users towards purchase of one or more goods, products, services, or the like provided by one or more third party entities (e.g., retail merchants, online retail merchants, or the like). The one or more third party systems 201 may be systems associated with the one or more third party entities. The one or more interaction devices 202 may be any devices that facilitates execution of resource interactions by users 110 at third party entity locations associated with the one or more third parties. The network processors 203 may be any payment card network processors that are linked with the resource credentials issued by the entity.

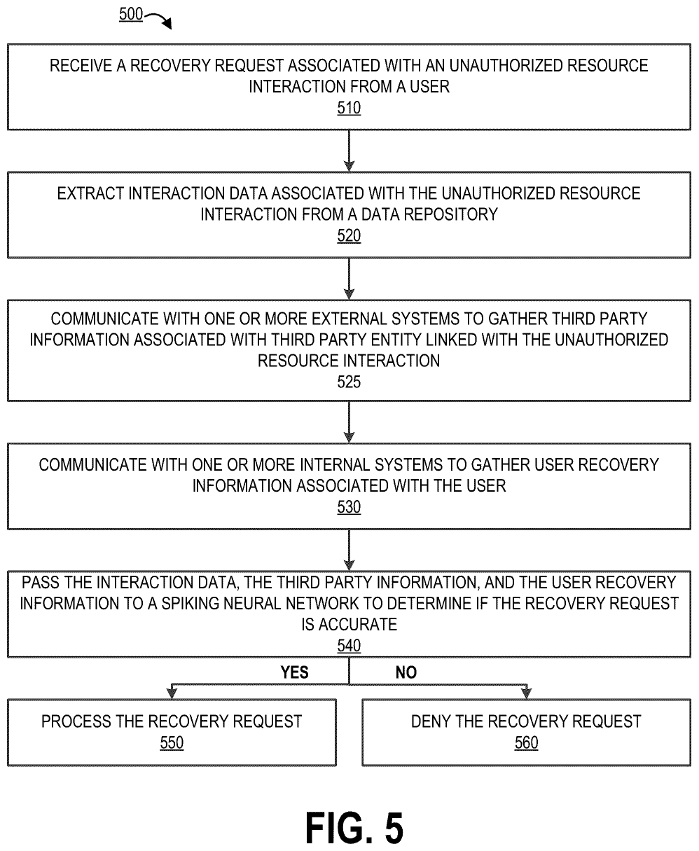

The misappropriated interaction recovery system 300 is a system of the present invention for performing one or more process steps described herein. In some embodiments, the misappropriated interaction recovery system 300 may be an independent system. In some embodiments, the misappropriated interaction recovery system 300 may be a part of the entity system 200. In some embodiments, the misappropriated interaction recovery system 300 may be controlled, owned, managed, and/or maintained by the entity associated with the entity system 200. The neuromorphic computing device 301 may be employed by the misappropriated interaction recovery system 300 to perform one or more operations described in FIG. 5. In some embodiments, the neuromorphic computing device 301 may be a part of the misappropriated interaction recovery system 300. In some embodiments, the neuromorphic computing device 301 may be a linked with the misappropriated interaction recovery system 300 to perform the one or more operations described herein. In some embodiments, the neuromorphic computing device 301 may comprise hardware that mimics the structure of neurons and may perform functions resembling the neurons. The hardware of the neuromorphic computing device 301 may comprise oxide-based memristors, spintronic memories, threshold switches, transistors, and/or the like. The neuromorphic computing device 301 may further comprise software components that implement models of neural systems. In some embodiments, the misappropriated interaction recovery system 300 may comprise the hardware and software components similar to that of the neuromorphic computing device 301 to perform the one or more operations described herein. In some embodiments, the misappropriated interaction recovery system 300 may transmit one or more instructions to components of the neuromorphic computing device 301, where the one or more instructions cause the neuromorphic computing device 301 to perform one or more operations described herein.

The misappropriated interaction recovery system 300, the neuromorphic computing device 301, the entity system 200, the computing device system 400, the one or more third party systems 201, the one or more interaction devices 202, and the network processors 203 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the misappropriated interaction recovery system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the misappropriated interaction recovery system 300, and/or entity system 200 across the network 150.

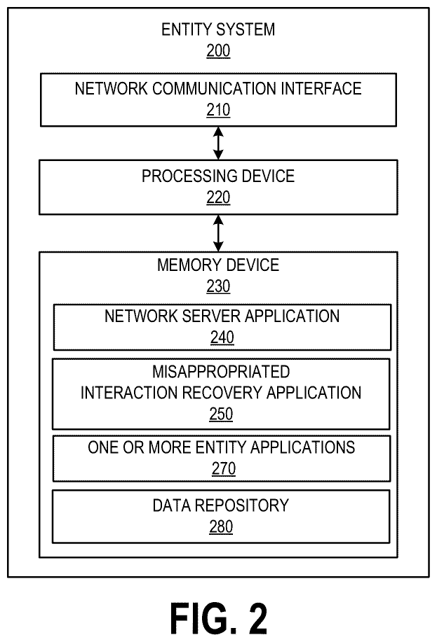

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a misappropriated interaction recovery application 250, one or more entity applications 270, and a data repository 280 comprising historical transaction data, historical product level data associated with one or more transactions performed by the users, and the like. The one or more entity applications 270 may be any applications developed, supported, maintained, utilized, and/or controlled by the entity. The computer-executable program code of the network server application 240, the misappropriated interaction recovery application 250, the one or more entity application 270 to perform certain logic, data-extraction, and data-storing functions of the entity system 200 described herein, as well as communication functions of the entity system 200.

The network server application 240, the misappropriated interaction recovery application 250, and the one or more entity applications 270 are configured to store data in the data repository 280 or to use the data stored in the data repository 280 when communicating through the network communication interface 210 with the misappropriated interaction recovery system 300, and/or the computing device system 400 to perform one or more process steps described herein. In some embodiments, the entity system 200 may receive instructions from the misappropriated interaction recovery system 300 via the misappropriated interaction recovery application 250 to perform certain operations. The misappropriated interaction recovery application 250 may be provided by the misappropriated interaction recovery system 300. The one or more entity applications 270 may be any of the applications used, created, modified, facilitated, developed, and/or managed by the entity system 200.

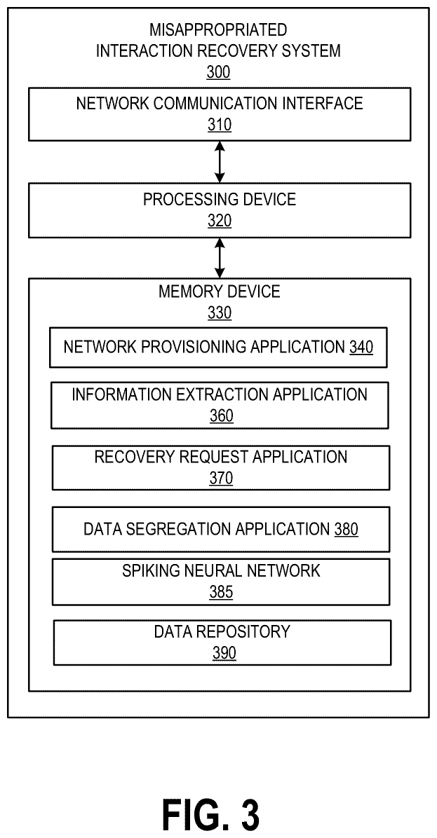

FIG. 3 provides a block diagram illustrating the misappropriated interaction recovery system 300 in greater detail, in accordance with embodiments of the invention. As illustrated in FIG. 3, in one embodiment of the invention, the misappropriated interaction recovery system 300 includes one or more processing devices 320 operatively coupled to a network communication interface 310 and a memory device 330. In certain embodiments, the misappropriated interaction recovery system 300 is operated by an entity, such as a financial institution. In some embodiments, the misappropriated interaction recovery system 300 is owned or operated by the entity of the entity system 200. In some embodiments, the misappropriated interaction recovery system 300 may be an independent system. In alternate embodiments, the misappropriated interaction recovery system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the misappropriated interaction recovery system 300 and to perform one or more processing functions described herein. For example, in one embodiment of the misappropriated interaction recovery system 300, the memory device 330 includes, but is not limited to, a network provisioning application 340, an information extraction application 360, a recovery request application 370, a data segregation application 380, a Spiking Neural Network 385, and a data repository 390 comprising any data processed or accessed by one or more applications in the memory device 330. The computer-executable program code of the network provisioning application 340, the information extraction application 360, the recovery request application 370, the data segregation application 380, and the Spiking Neural Network 385 may instruct the processing device 320 to perform certain logic, data-processing, and data-storing functions of the misappropriated interaction recovery system 300 described herein, as well as communication functions of the misappropriated interaction recovery system 300.

The network provisioning application 340, the information extraction application 360, the recovery request application 370, the data segregation application 380, and the Spiking Neural Network 385 are configured to invoke or use the data in the data repository 390 when communicating through the network communication interface 310 with the entity system 200, and/or the computing device system 400. In some embodiments, the network provisioning application 340, the information extraction application 360, the recovery request application 370, the data segregation application 380, and the Spiking Neural Network 385 may store the data extracted or received from the entity system 200, and the computing device system 400 in the data repository 390. In some embodiments, the network provisioning application 340, the information extraction application 360, the recovery request application 370, the data segregation application 380, and the Spiking Neural Network 385 may be a part of a single application (e.g., modules).

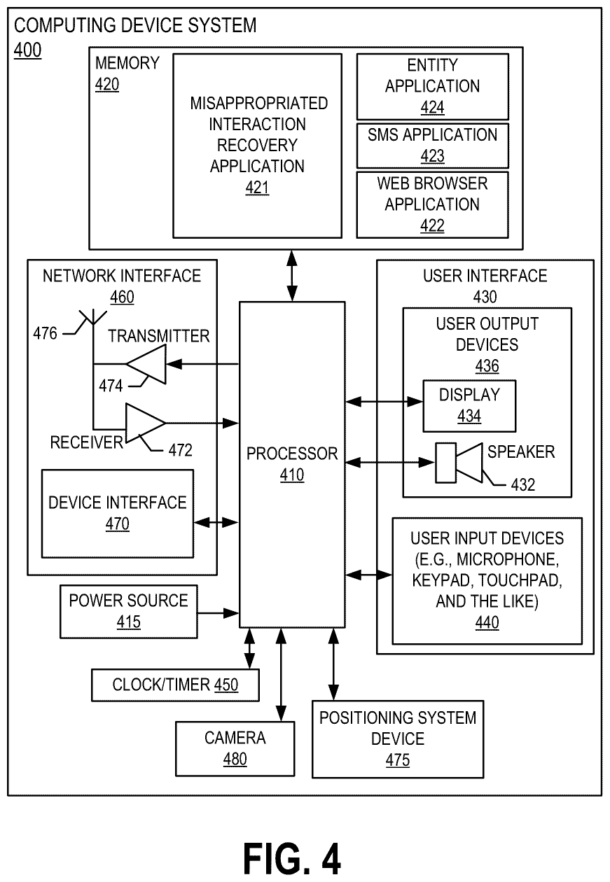

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a misappropriated interaction recovery application 421, entity application 424. These applications also typically instructions to a graphical user interface (GUI) on the display 430 that allows the user 110 to interact with the entity system 200, the misappropriated interaction recovery system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the misappropriated interaction recovery application 421 provided by the misappropriated interaction recovery system 300 allows the user 110 to access the misappropriated interaction recovery system 300. In some embodiments, the entity application 424 provided by the entity system 200 and the misappropriated interaction recovery application 421 allow the user 110 to access the functionalities provided by the misappropriated interaction recovery system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a flowchart 500 illustrating a process flow for performing recovery of misappropriated interactions via neuromorphic computing, in accordance with an embodiment of the invention. As shown in block 510, the system receives a recovery request associated with an unauthorized resource interaction from a user. The recovery request may be associated with recovery of resources associated with the unauthorized resource interaction which may have been performed by an unauthorized user using misappropriated resource credential of the user. For example, the user may review a statement associated with a resource pool associated with the misappropriated resource credential and may initiate the recovery request. In some embodiments, after receiving the recovery request, the system may determine if the unauthorized resource interaction is really a misappropriated resource interaction by employing processes described in U.S. patent application titled “SYSTEM AND METHOD FOR PERFORMING MISAPPROPRIATION DETECTION AND PREVENTION USING SIAMESE NEURAL NETWORKS” filed concurrently herewith, which is hereby incorporated by reference in its entirety. In some such embodiments, the process flow proceeds to block 520 only after determining that the unauthorized resource interaction is really a misappropriated resource interaction.

As shown in block 520, the system extracts interaction data associated with the unauthorized resource interaction from a data repository. In some embodiments, the system may capture interaction data by communicating with interaction devices (e.g., Point of Transaction devices) used to initiate all resource interactions, where the resource interactions may be initiated by authorized users or unauthorized users. In some embodiments, the interaction data may be extracted from entity systems (e.g., financial institutions), third party systems (merchant systems), and/or any other systems involved in the distribution of resources associated with the resource interactions. Interaction data may comprise product information, resource credential information (e.g., credit card information), execution related data associated with the resource interaction. In some embodiments, the system may capture behavioral data associated with user (i.e., authorized user or unauthorized user) who initiated the resource interaction.

As shown in block 525, the system communicates with one or more external systems to gather third party information associated with third party entity linked with the unauthorized resource interaction. Third party information may comprise number of times third party entity's recovery of resources has been in good faith, amount associated with historical recovery requests associated with the third party entity, number of times the third party entity denied recovery requests, number of times recovery requests linked with the third party entity were accurate, number of times recovery requests linked with the third party entity were inaccurate, and/or the like. The external systems may be payment card network processors (e.g., network processors) associated the resource credentials linked with the unauthorized resource interaction.

As shown in block 530, the system communicates with one or more internal systems to gather user recovery information associated with the user. The user recovery information may comprise number of times recovery requests initiated by the user were accurate or inaccurate, amount associated with recovery requests initiated by the user, number of recovery requests submitted by the user that were successful and unsuccessful, amount associated with successful recovery requests submitted by the user, amount associated with unsuccessful recovery requests submitted by the user, number of times the user initiated a postprocessing recovery request after completion of processing of initial recovery request, and/or the like. The internal systems may be any systems associated with the entity managing and/or maintaining resource pools associated with the resource credentials used in the unauthorized resource interaction.

As shown in block 540, the system passes the interaction data, the third party information, and the user recovery information to a Spiking Neural Network to determine if the recovery request is accurate. The Spiking Neural Network may analyzes the interaction data, the third party information, and the user recovery information to determine if the recovery request is accurate or not. The Spiking Neural Network may mimic the way biological neurons work to determine if the recovery request is accurate or not. In one example, the system may analyze the data to determine that the historical recovery requests initiated by the customer were successful, the third party entity involved in historical unauthorized transactions, the amount associated with the recovery request is not on par with standard transaction amounts associated with the user, and may provide a consensus that the recovery request is accurate and has a high chance that the recovery of resources will be successful. In another example, the system may analyze the inputs and may provide a consensus that the recovery request may not be accurate which may lead to failure of the recovery of resources and that manual review of the request may be required. In some embodiments, the system extracts all historical resource interaction data associated with the user and the third party entity and may pass it to the Spiking Neural Network to include in the analysis of determining if the recovery request is accurate or not.

If the system determines that the recovery request is accurate, the process flow process to block 550. As shown in block 550, the system processes the recovery request. If the system determines that the recovery request is not accurate, the process flow process to block 560. As shown in block 560, the system denies the recovery request.

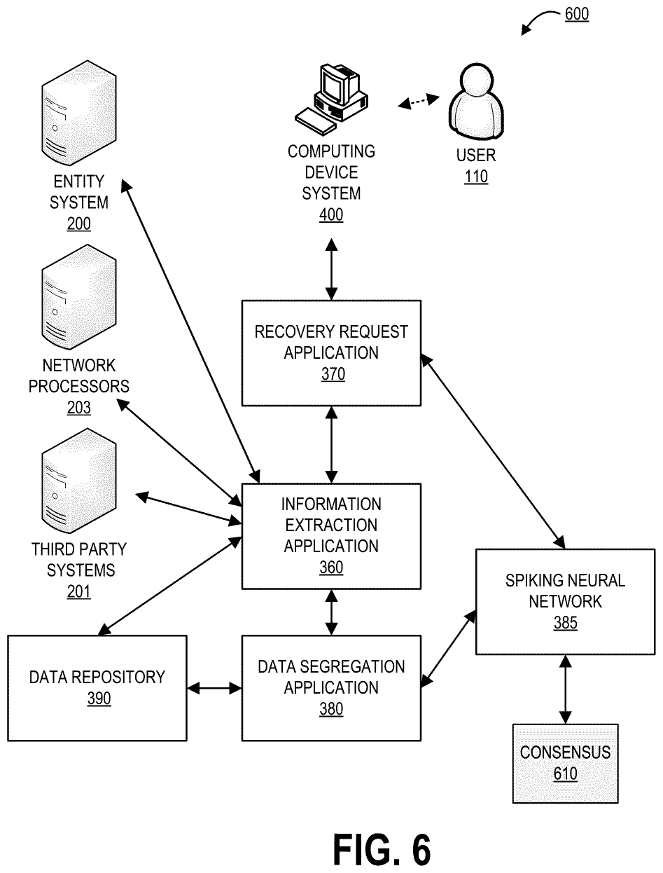

FIG. 6 provides a block diagram illustrating the process of performing recovery of misappropriated interactions via neuromorphic computing, in accordance with an embodiment of the invention. As shown, the recovery request application 370 may receive a recovery request associated with an unauthorized resource interaction via the computing device system of the user 110. The recovery request application 370 may transmit the information associated with the recovery request to the information extraction application 360 which then extracts the interaction data, the third party information, and the user recovery information from the data repository 390, the entity systems 200, the third party entity systems 201, and the network processors 203. The data segregation application 380 may then segregate the data extracted by the information extraction application and pass the segregated information to the Spiking Neural Network 385, where the Spiking Neural Network 385 processes the inputs to arrive at a consensus 610 that determines if the recovery request is accurate or not.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent application:

| | U.S. patent | | |
|---|---|---|---|
| | application | | |
| Docket Number | Ser. No. | Title | Filed On |
| 15879US1.014033.5005 | To be | SYSTEM AND METHOD FOR | Concurrently |
| | assigned | PERFORMING MISAPPROPRIATION | herewith |
| | | DETECTION AND PREVENTION | |
| | | USING SIAMESE NEURAL NETWORKS | |

1. A system for performing recovery of misappropriated interactions via neuromorphic computing, the system comprising:
at least one network communication interface;
at least one non-transitory storage device; and
at least one processing device coupled to the at least one non-transitory storage device and the at least one network communication interface, wherein the at least one processing device is configured to:
receive a recovery request associated with an unauthorized resource interaction from a user;
extract interaction data associated with the unauthorized resource interaction from a data repository;
communicate with one or more external systems to gather third party information associated with third party entity linked with the unauthorized resource interaction;
communicate with one or more internal systems to gather user recovery information associated with the user;
pass the interaction data, the third party information, and the user recovery information to a Spiking Neural Network to determine if the recovery request is accurate; and
process or deny the recovery request based on determining if the recovery request is accurate.

2. The system of claim 1, wherein the Spiking Neural Network is part of a neuromorphic computing device.

3. The system of claim 2, wherein the system comprises the neuromorphic computing device.

4. The system of claim 2, wherein the system is linked with the neuromorphic computing device.

5. The system of claim 1, wherein the at least one processing device is configured to capture the interaction data during execution of the unauthorized resource interaction.

6. The system of claim 1, wherein the resource interaction is an online interaction.

7. The system of claim 1, wherein the resource interaction is an in-store interaction.

8. A computer program product for performing recovery of misappropriated interactions via neuromorphic computing, the computer program product comprising a non-transitory computer-readable storage medium having computer executable instructions for causing a computer processor to perform the steps of:
receiving a recovery request associated with an unauthorized resource interaction from a user;
extracting interaction data associated with the unauthorized resource interaction from a data repository;
communicating with one or more external systems to gather third party information associated with third party entity linked with the unauthorized resource interaction;
communicating with one or more internal systems to gather user recovery information associated with the user;
passing the interaction data, the third party information, and the user recovery information to a Spiking Neural Network to determine if the recovery request is accurate; and
processing or denying the recovery request based on determining if the recovery request is accurate.

9. The computer program product of claim 8, wherein the Spiking Neural Network is part of a neuromorphic computing device.

10. The computer program product of claim 9, wherein the system comprises the neuromorphic computing device.

11. The computer program product of claim 9, wherein the system is linked with the neuromorphic computing device.

12. The computer program product of claim 8, wherein the computer executable instructions cause the computer processor to perform the step of capturing the interaction data during execution of the unauthorized resource interaction.

13. The computer program product of claim 8, wherein the resource interaction is an online interaction.

14. The computer program product of claim 8, wherein the resource interaction is an in-store interaction.

15. A computer implemented method for performing recovery of misappropriated interactions via neuromorphic computing, wherein the method comprises:
receiving a recovery request associated with an unauthorized resource interaction from a user;
extracting interaction data associated with the unauthorized resource interaction from a data repository;
communicating with one or more external systems to gather third party information associated with third party entity linked with the unauthorized resource interaction;
communicating with one or more internal systems to gather user recovery information associated with the user;
passing the interaction data, the third party information, and the user recovery information to a Spiking Neural Network to determine if the recovery request is accurate; and
processing or denying the recovery request based on determining if the recovery request is accurate.

16. The computer implemented method of claim 15, wherein the Spiking Neural Network is part of a neuromorphic computing device.

17. The computer implemented method of claim 16, wherein the system comprises the neuromorphic computing device.

18. The computer implemented method of claim 16, wherein the system is linked with the neuromorphic computing device.

19. The computer implemented method of claim 15, wherein the resource interaction is an online interaction.

20. The computer implemented method of claim 15, wherein the resource interaction is an in-store interaction.
